(19) United States
(12) Patent Application Publication
(10) Pub. No.: US 2021/0154875 A1
(43) Pub. Date: May 27, 2021

(54) METHOD FOR CUTTING A RUBBER WEB

(71) Applicant: Herrmann Ultraschalltechnik GMBH & Co. KG, Karlsbad (DE)

(72) Inventor: Christoph Ochs, Malsch (DE)

(21) Appl. No.: 16/618,249

(22) PCT Filed: Aug. 21, 2018
(86) PCT No.: PCT/EP2018/072528

§ 371 Date: Nov. 29, 2019

(30) Foreign Application Priority Data
Aug. 23, 2017 (DE) 10 2017 119 279.4

(51) Int. Cl. B26D 7/08; B29D 30/06; B26D 3/00; B26D 1/00

(52) U.S. Cl. CPC B26D 7/086; B29D 30/0681; B26D 7/10; B26D 1/0006; B26D 3/003

(57) ABSTRACT

The present invention concerns a method of cutting a rubber web by means of ultrasound, in which a sonotrode comes into contact with the rubber web and the rubber web and the sonotrode are moved relative to each other while the sonotrode is excited with an ultrasonic vibration. To provide a method of the kind set forth in the opening part of this specification which allows reliable cutting of a rubber web and at the same time ensures that the wear of the tool and the converter is markedly reduced according to the invention it is proposed that a sonotrode comprising steel, preferably hardened steel, is used.

The present invention concerns a method of cutting a rubber web by means of ultrasound.

Rubber webs are cut for example for the production of tyres. In the production of tyres firstly a rubber mix is produced, the composition of which depends on the requirements made by the tyre to be produced. In general the rubber mix contains about 40% of natural or synthetic rubber. It is usual to add further fillers like for example carbon black, silicate and chemical additives as well as chalk, oils, resins, accelerators, retarders, mixing aids, activators and sulphur.

That mixture is injected into a so-called extruder through shaping nozzles, thereby resulting in a rubber web in accordance with the present invention. The term rubber web is therefore used to denote a material web which contains rubber and optionally further fillers.

That rubber web has to be cut to size in order to produce treads, side walls and other structural elements of the tyre.

It is already known to use a tool having a cutting edge, that is activated to produce an ultrasonic vibration, for cutting the rubber webs to size. The tools used for that purpose comprise titanium alloys. They are not infrequently designed and operated in such a way that they work at a working frequency of 40 kHz.

In the known ultrasound cutting machines for cutting rubber webs however a high degree of wear of the tool and the converter driving the tool is to be observed. In addition the cut which can be achieved with the tool is rather irregular so that overlapping the ends of the cut rubber web, in correct positional relationship, is only possible with difficulty.

In addition rubber residues frequently remain on the tool, and they have to be removed in a separate cleaning step. Even if cutting rubber webs by means of ultrasound in principle works well the described problems increase the costs linked to the cutting operation.

Taking the described state of the art as the basic starting point therefore the object of the present invention is to provide a method of the kind set forth in the opening part of this specification, which allows reliable cutting of a rubber web and at the same time ensures that the wear of the tool and the converter is markedly reduced.

According to the invention that object is attained in that a sonotrode of steel and indeed preferably hardened steel is used as the tool.

It has been found that the titanium alloys used hitherto for that application are of only comparatively poor thermal conductivity and the sonotrode is greatly heated by virtue of the cutting material contact. By virtue of the high working temperature of the sonotrode material residues remain clinging thereto, and that reduces the cutting quality and also results in contamination of the equipment.

In addition, in spite of the relatively soft material to be worked, the titanium alloy is evidently too soft as in practice a great amount of wear is found to occur, in particular resulting in pieces breaking off at the sonotrode cutting edge.

The wear of the ultrasound cutting equipment can be markedly reduced by the use of steel, preferably CPM, that is to say a powder-metallurgical steel.

In a further preferred embodiment a sonotrode is used, which has a wedge-shaped tip. The wedge-shaped tip is brought into engagement with the rubber web to be cut, during the cutting operation, and the rubber web and the sonotrode are moved relative to each other so that the wedge-shaped tip cuts through the rubber web.

The wedge-shaped tip preferably has a rectangular separating surface with a width and a length. The separating surface is that surface which is directed in opposition to the rubber web. In a preferred embodiment the width of the rectangular separating surface is <0.2 mm and best between 0.02 mm and 0.1 mm.

By virtue of the fact that the thermal conductivity of the steel used is markedly greater than the thermal conductivity of the known titanium alloys there is a lesser increase in temperature of the sonotrode during the cutting operation with the consequence that less material remains clinging to the sonotrode.

The use of steel then also has the advantage that the length of the separating surface can be reduced so that in a preferred embodiment it is <60 mm, preferably <50 mm and particularly preferably between 25 and 35 mm.

As the generation of heat at the cutting edge or the separating surface substantially depends on the cutting speed the reduction in the length of the separating surface provides that the material cross-section which is operative in terms of thermal conductivity is reduced so that less heat can be dissipated from the material web by the sonotrode, with the consequence that the sonotrode heats up more greatly. Therefore the length of the separating surface should also not be selected to be too small. In any case the length of the sonotrode must be greater than or equal to the thickness of the rubber web to be cut.

The risk of material adhering to the sonotrode can be further reduced by using a sonotrode which is coated at least at portions which are intended to come into contact with the rubber web, wherein preferably a non-stick coating like for example a Teflon coating is used as the coating.

In a further preferred embodiment it is provided that the sonotrode is cooled during the cutting operation. For example cooling of the sonotrode can be effected by means of a cooling air flow directed on to the sonotrode. Suitable cooling air nozzles can be fixed for example to the converter.

The method step of cooling the sonotrode reduces the risk of rubber material being burnt and corresponding rubber residues adhering to the sonotrode.

In a further preferred embodiment the sonotrode is excited with an ultrasonic frequency <38 kHz, wherein preferably the excitation frequency is between 32 and 37 kHz and particularly preferably between 34 and 36 kHz.

It is basically the case that, the higher the ultrasonic sonotrode excitation frequency is at a constant vibration amplitude, the correspondingly greater is the contribution of the ultrasonic processing effect in the cutting operation.

As already mentioned in the opening part of this specification therefore excitation frequencies in the region of 40 kHz are usual. When dealing with rubber webs however such a frequency appears to be disadvantageous. Even if that has hitherto not been completely investigated the use of an ultrasonic frequency of 40 kHz evidently leads to severe stressing of the sonotrode and the entire ultrasonic vibration system. The ultrasonic vibration system comprises the sonotrode which has already been mentioned and a converter and optionally an amplitude transformer disposed between the sonotrode and the converter. The ultrasonic vibration system is put overall into an acoustic ultrasonic vibration state. The piezomodules arranged in the converter to convert an electric ac voltage into a mechanical vibration are extremely loaded at a vibration frequency of 40 kHz and when cutting rubber webs, and that results in premature failure. A marked improvement is observed here by reducing the excitation frequency to the specified ranges.

In a further preferred embodiment there is provided a clamping device used to clamp a holding element to the converter or the amplitude transformer. The holding element is therefore not screwed to the ultrasonic vibration unit but is only clamped thereto. The holding element can then be fixed to the machine stand or a feed unit so that the ultrasonic vibration unit can be fed relative to the rubber web by movement of the holding element.

In a further preferred embodiment the sonotrode and the converter are arranged on a tool axis, wherein the tool axis includes an angle of between 30 and 70°, preferably between 40 and 60° and particularly preferably about 50° with a normal on the rubber web. That produces an inclined cut edge which has been found to be advantageous for further processing of the cut rubber web.

In a further preferred embodiment the longitudinal direction of the separating surface includes an angle of between 10 and 20°, preferably between 12 and 16° and particularly preferably between 14 and 15°, with the rubber web. If now the sonotrode is moved laterally, that is to say in the plane defined by the tool axis and the longitudinal direction of the separating surface, perpendicularly to the tool axis, that gives a cut angle which coincides with the specified angle ranges.

In a further preferred embodiment it is provided that the method is carried out with a cutting speed of between 1.5 and 4 mm/s, particularly preferably between 2 and 3 mm/s and best at about 2.5 mm/s.

Further advantages, features and possible uses of the present invention will be apparent from the description hereinafter of a preferred embodiment and the accompanying Figures in which:

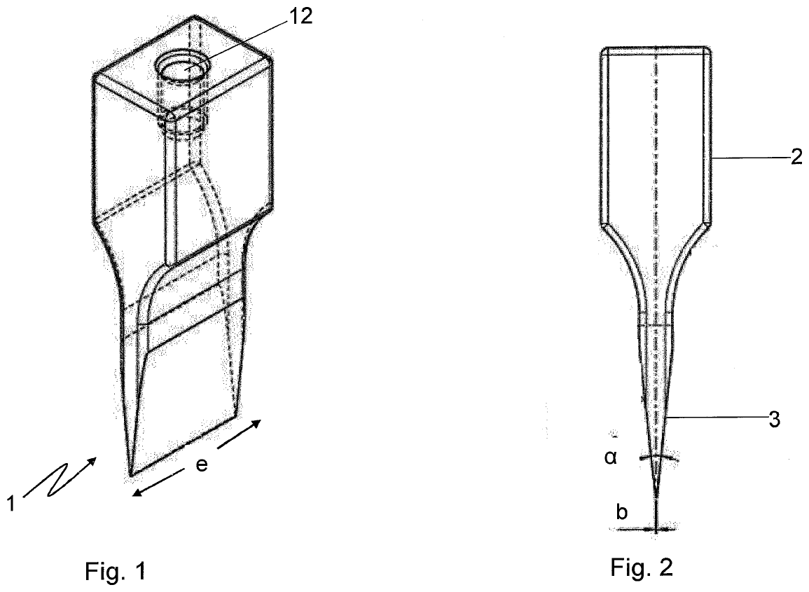

FIG. 1 shows a perspective view of a sonotrode as is used for the method according to the invention,

FIG. 2 shows a side view of the sonotrode of FIG. 1,

FIG. 3 shows an exploded view of an ultrasonic cutting installation, and

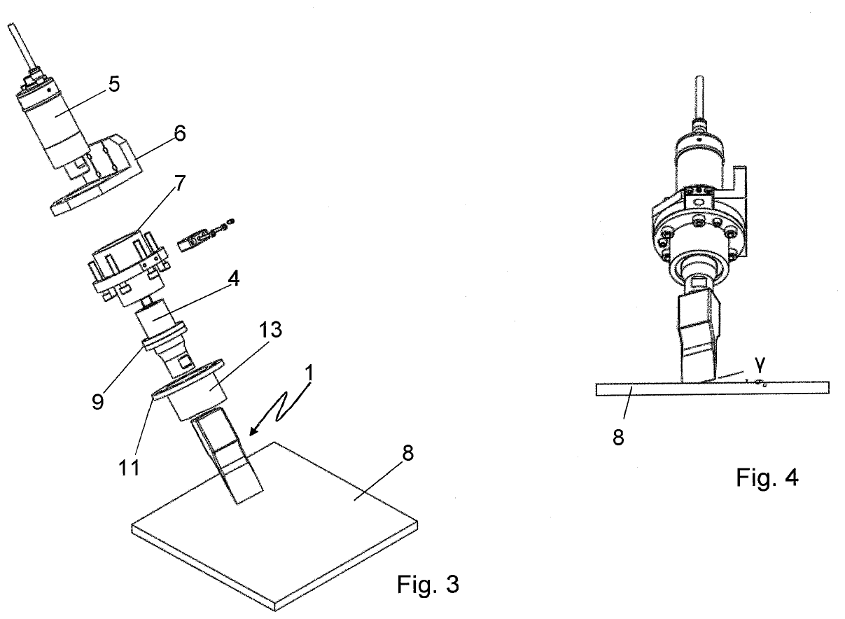

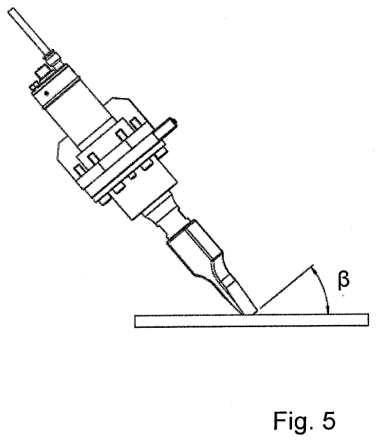

FIGS. 4 and 5 show two perspective views of the ultrasonic processing installation of FIG. 3.

FIG. 1 shows a perspective view of a sonotrode 1 which can be used in the method according to the invention. It is produced from steel, more specifically CPM 420 V. The sonotrode 1 has a threaded bore 12 at which a converter or an amplitude transformer adjoining the sonotrode 1 can be fixed. Disposed on the side of the sonotrode 1, in opposite relationship to the threaded bore 12, is the separating surface which is of a length l.

FIG. 2 shows a side view of the sonotrode 1 of FIG. 1. The sonotrode 1 has a main body 2 and an adjoining wedge-shaped portion 3, at the tip of which is arranged the separating surface which is of a width b. The wedge-shaped portion 3 has a taper angle α which is at best between 8 and 15°.

FIG. 3 shows an exploded view of an ultrasonic processing installation for cutting rubber webs 8. It is possible to see the sonotrode 1 which is shown in detail in FIGS. 1 and 2 and which is connected to a converter 5 by way of an amplitude transformer 4. The converter 5 converts an electric ac voltage into a mechanical vibration. Generally piezoelements are used for that purpose.

The mechanical vibration generated by the converter is converted in the amplitude transformer into a vibration at the same frequency, but under some circumstances of different amplitude. That is then transmitted to the sonotrode 1 so that an acoustic ultrasound wave is propagated from the converter 5 by way of the amplitude transformer 4 into the sonotrode 1. The separating surface, that is to say the tip of the wedge-shaped element 3, thus presents a vibration which supports cutting of the rubber web 8. In order to hold the ultrasonic vibration unit consisting of the converter 5, the amplitude transformer 4 and the sonotrode 1 there is a holding element 6 which however is not screwed to same. Instead the holding element 6 is connected to a hollow cylinder 7 which has an outwardly projecting flange. Arranged in the flange are a series of screws which hold on the one hand the clamping element 13 and on the other hand the holding element 6.

In this case clamping is effected in a region of the amplitude transformer, in which a vibration node of the ultrasonic vibration is formed in order to influence the ultrasonic vibration system as little as possible in its vibration characteristic by virtue of the clamping action. The amplitude transformer therefore has a holding flange 9 in that region. The clamping element 13 has a step bore (not shown), the bore portion of smaller diameter of which is of a diameter which is less than the diameter of the holding flange 9 of the amplitude transformer 4 so that in the assembled state the amplitude transformer 4 is clamped at its holding flange 9 between the clamping element 13 and the fixing flange of the hollow cylinder 7.

FIGS. 4 and 5 show two perspective views. It will be seen from FIG. 4 that the separating surface includes with the plane of the rubber web 8 a cut angle γ which should preferably be between 4 and 5°.

FIG. 5 shows that the longitudinal axis of the ultrasonic vibration system is tilted through an angle β with respect to the normal on the plane of the rubber web 8.

### LIST OF REFERENCES

1 Sonotrode
2 Main body
3 Wedge-shaped portion
4 Amplitude transformer
5 Converter
6 Holding element
7 Hollow cylinder
8 Rubber web
9 Holding flange
11 Fixing flange
12 Threaded bore
13 Clamping element

1. A method of cutting a rubber web by means of ultrasound, the method comprising:
contacting the rubber web with a sonotrode and
moving the rubber web and the sonotrode relative to each other while the sonotrode is excited in an ultrasonic vibration, the sonotrode comprising steel.

2. A method according to claim 1 characterised in that the sonotrode has a wedge-shaped tip.

3. A method according to claim 11 characterised in that the length of the separating surface is <60 mm.

4. A method according to claim 1 characterised in that the sonotrode is coated at least at portions which are intended to come into contact with the rubber web.

5. A method according to claim 1 characterised in that the sonotrode is cooled during the cutting operation.

6. A method according to claim 1 characterised in that the sonotrode is excited with an ultrasonic frequency of less than 38 kHz.

7. A method according to claim 1 characterised in that the sonotrode is connected to a converter by way of an amplitude transformer, wherein a clamping device is used, with which a holding element can be clamped to the converter or the amplitude transformer.

8. A method according to claim 1 characterised in that the sonotrode and the converter are arranged on a tool axis, wherein the tool axis includes an angle of between 30° and 70° with a normal on the rubber web.

9. A method according to claim 1 characterised in that the longitudinal direction of the separating surface includes an angle of between 10 and 20° with the rubber web.

10. A method according to claim 1 characterised in that the method is carried out with a cutting speed of between 1.5 and 4 mm/s.

11. A method according to claim 2 characterised in that the wedge-shaped tip has a rectangular separating surface with a width and a length.

12. A method according to claim 1 wherein the sonotrode comprises hardened steel.

13. A method according to claim 3 characterised in that the length of the separating surface is between 25 and 35 mm.

14. A method according to claim 4 characterised in that the coating is Teflon.

15. A method according to claim 5 characterised in that the sonotrode is cooled by means of a cooling air flow directed onto the sonotrode.

16. A method according to claim 6 characterised in that the sonotrode is excited with an ultrasonic frequency of between 34 and 36 kHz.

17. A method according to claim 9 characterised in that the longitudinal direction of the separating surface includes an angle of between 14 and 15° with the rubber web.

18. A method according to claim 10 characterised in that the method is carried out with a cutting speed of about 2.5 mm/s.
